(19) United States
(12) Patent Application Publication
(10) Pub. No.: US 2013/0346142 A1
(43) Pub. Date: Dec. 26, 2013

(54) INTERNET TRANSACTION ANALYSIS SYSTEM AND METHOD

(71) Applicant: BUYBUDDIE LIMITED, County Clare (IE)

(72) Inventor: Joseph Young, County Clare (IE)

(21) Appl. No.: 13/914,307

(22) Filed: Jun. 10, 2013

Related U.S. Application Data
(63) Continuation of application No. PCT/GB2011/052459, filed on Dec. 12, 2011.

(30) Foreign Application Priority Data
Dec. 10, 2010 (GB) 1020973.2

(51) Int. Cl. G06Q 10/06

(52) U.S. Cl. CPC G06Q 10/0635
USPC 705/7.28

(57) ABSTRACT

An internet transaction analysis system and method are disclosed. The system comprises a processing unit and a data communication arrangement, the processing unit being arranged to receive, via the data communication arrangement, data on a transaction, the transaction being associated with internet activity at a remote user terminal, the processing unit being arranged to apply a plurality of checks to the data on the transaction, generate a value for a risk metric in dependence on the results of the checks and cause an indicator on the relative risk of the transaction to be output at the user terminal, the indicator of the relative risk being determined in dependence on the value for the risk metric.

This application is a continuation under 35 U.S.C. §120 of International PCT Patent Application No. PCT/GB2011/052459, filed on Dec. 12, 2011, which claims the benefit of Great Britain Application No. 1020973.2, filed Dec. 10, 2010, which are hereby incorporated by reference in their entirety herein.

### FIELD OF THE INVENTION

The present invention relates to an internet transaction analysis system and method and in particular to an internet transaction analysis system and method that is particularly applicable to automated system for transparent use in web based transactions.

### BACKGROUND TO THE INVENTION

For every transaction, there is a perceived sense of risk before, during and after the completion of the transaction. Questions remain for most consumers; is the price fair? Can I trust this vendor? Is there small print I missed? Is the product safe?

In the case of physical bricks and mortar stores where the consumer can evaluate the store, the merchant and the merchandise before committing to a purchase, contract or the like, it is often straightforward to guess, for example, whether the goods are genuine and whether the store may still be around in a month's time if the goods turn out to be faulty. However, such an assessment is far more difficult in the case of online transactions such as with web based retailers or transactions using web based intermediaries such as online auction sites. It is very difficult to assess who you are dealing with, where they may be located and what their policies may be. Indeed, once the transaction becomes one conducted over the internet, far more issues become relevant. For example, it is far easier for someone to set up trading online—no premises are needed as customer visits are not needed to complete the purchase; online “stores”can be quickly configured through most internet service providers to give a professional image or even establish operations in a country far distant to that or the seller without being immediately apparent to the consumer that is the case.

Current end user computer systems provide guidance on security such as viruses, malware and the like. However, during transactions, these risks only normally arise in the most extreme cases. It is typically left to the consumer to select the site to use, often based on search engine results and/or the cheapest price.

Consumers have no easy way of assessing risk and identifying pitfalls when making transactions online. In the UK, 77% of online transactions encounter some sort of issue. According to reports, possibly more than 55% of retail websites break European Union laws such as those on distance selling and privacy. Identification and management of potential risks are very often beyond the capability of the consumer.

Clicking on the buy button always seems like a risk. When an issue is encountered, 46% of consumers abandon the transaction and 40% change retailers. According to the UK Office of Fair Trading, 33% of consumers refuse to purchase online because of fear. Surveys show 70% of online consumers trust online reviews posted by people they don't know. It affects 50% of online purchases.

Current accreditation marks or arbitrary subjective social media results may be presented by sites. These often give the consumer a false sense of security. As a result, consumers are using flawed ‘emotionally’ based information to make buying decisions. The present invention addresses this and other problems in the art.

### SUMMARY OF THE INVENTION

According to an aspect of the present invention, there is provided an internet transaction analysis system comprising a processing unit and a data communication arrangement, the processing unit being arranged to receive, via the data communication arrangement, data on a transaction, the transaction being associated with internet activity at a remote user terminal, the processing unit being arranged to apply a plurality of checks to the data on the transaction, generate a value for a risk metric in dependence on the results of the checks and cause an indicator on the relative risk of the transaction to be output at the user terminal, the indicator of the relative risk being determined in dependence on the value for the risk metric.

The internet activity may comprise web browsing, the internet analysis system being arranged to cause the indicator of the relative risk to be visible during said web browsing.

The indicator may include a graphical element that is varied in dependence on the relative risk being indicated. The graphical element may include a representation of a character, one or more attributes of the character being varied in dependence on the relative risk being indicated. The attributes may include facial expression; posture; dress; illustrated activity; animation; and, gesture. At least a part of the indicator may be coloured, the colour being varied in dependence on the relative risk being indicated. The indicator may include a numeric value corresponding to the value for the risk metric.

The indicator may be displayed at the remote user terminal in one or more of a toolbar associated with the web browser; a transparent layer superimposed over at least part of a web page displayed by the web browser, a popup window or, a taskbar of the remote terminal.

The indicator may be actuable by a user input at the remote user terminal. The indicator may be arranged, in response to actuation, to display data at the remote user terminal on the relative risk.

The internet transaction analysis system may be arranged to identify one or more alternative web sites relevant to the internet activity and having a lower relative risk and to cause an identifier for each of said one or more alternative web sites to displayed to the user at the remote user terminal.

The internet transaction analysis system may be further arranged to cause redirection of the web browsing activity to a respective alternative web site upon selection of the respective identifier by a user at the remote user terminal. The indicator may include said identifiers for each of said one or more alternatives.

Preferably, the processing unit is arranged to cause the outputted indicator to be updated over time in response to internet activity at the remote user terminal.

The system may further comprise a user terminal component arranged to be executed at the remote user terminal and, upon execution, to cause data on said internet activity to be transmitted to said data communication arrangement.

The data communication arrangement may be arranged to receive data on the transaction from one or more remote systems party to the transaction.

The one or more remote systems may include ones selected from a set including: a web server responding to said internet activity; an e-commerce system responding to said internet activity; an online payment system requested to process the transaction.

The checks may be performed on targets selected from a set including:

the remote user terminal; an internet site that is target of the internet activity; a website that is target of the internet activity; an intermediary internet site that is party to the transaction: persons or companies linked to the internet site.

The checks may be performed on one or more of the targets are selected from a set including:

computer security; data transmission security; site data security; website security; website compliance of predetermined standards; reputation of a company associated with the target; social media references to the target; physical location of a company or individual providing the target; presence of contact information on the internet site that is target of the internet activity; credit reference checks on the target.

According to another embodiment of the present invention, there is provided an internet transaction analysis method comprising:

receiving data on a transaction, the transaction being associated with internet activity at a remote user terminal,

applying a plurality of checks to the data on the transaction;

generating a value for a risk metric in dependence on the results of the checks; and,

causing an indicator on the relative risk of the transaction to be output at the user terminal, the indicator of the relative risk being determined in dependence on the value for the risk metric.

It will be appreciated that the term “transaction” used herein may refer to one of many different activities. For example, it may refer to a financial transaction, a creation of need, a search, analysis, refinement, payment, post-payment review, communication by email, instant message or the like, access of a website or other internet site.

In embodiments of the present invention, data on a transaction associated with activity at a user terminal (which may be actions leading to a transaction, steps taken during making an online transaction actions concerning a future transaction, financial or non-financial transactions, web, internet or email based transactions etc) is obtained and passed to a processing system that is remote of the user terminal (typically a central server or a web based service). The remote processing system applies checks to the transaction data to identify a risk factor. The checks may vary depending on the user, the transaction, the transaction type, the assessed risk, the internet site that is the other party to the transaction or other factors. The remote processing system is then arranged to cause an indicator on the risk factor to be output at the user terminal.

Embodiments of the present invention seek to provide a system and method that transparently analyse transactions being undertaken by a user in order to identify potential issues with the online transaction and subsequently guide the consumer's decision to purchase or not. In preferred embodiments, a risk assessment system is used to present to the consumer an instant view of potential risk and, where necessary/desired/applicable guide them to safe alternatives.

Embodiments of the present invention approach analysis from the perspective that a consumer's decision to purchase a product or service from any website should be an informed decision, with all the known risks apparent to the consumer. Optionally, embodiments of the present invention may seek to offer safe alternatives and/or value added services associated with the transaction.

In an alternate embodiment of the present invention, data on a transaction associated with activity at a user terminal (which may be actions leading to a transaction, steps taken during making an online transaction actions concerning a future transaction, financial or non-financial transactions, web, internet or email based transactions etc) is obtained and passed to a processing system that is remote of the user terminal (typically a central server or a web based service). The remote processing system applies checks to the transaction data to identify a risk factor. The checks may vary depending on the user, the transaction, the transaction type, the assessed risk, the internet site that is the other party to the transaction or other factors. An insurance policy underwriting at least aspects of the transaction (for example, insuring the goods; insuring transport; insuring payment in the event of a merchant not completing the transaction) is then caused to be offered, terms and/or costs for the insurance policy being dependent on the risk factor. It will be appreciated that the remote processing system may be provided by or linked to an insurance underwriter. In addition, although this alternate embodiment may be implemented separately to the above mentioned embodiment (in which an indicator is output at the user terminal), it may be used in combination with that embodiment such that the indicator is output and an opportunity to purchase insurance connected to the transaction is offered via or alongside the indicator.

In yet another embodiment of the present invention, data on a transaction associated with activity at a user terminal (which may be actions leading to a transaction, steps taken during making an online transaction actions concerning a future transaction, web, internet or email based transactions etc) is obtained and passed to a processing system providing financial payment services for the user of the user terminal, the processing system being remote of the user terminal (typically a central server or a web based service). The remote processing system applies checks to the transaction data to identify a risk factor. The checks may vary depending on the user, the transaction, the transaction type, the assessed risk, the internet site that is the other party to the transaction or other factors. The use of the financial payment services may be blocked or subject to further cross-checks or conditions dependent on the risk factor. For example, a high risk transaction may be blocked completely whereas a moderate risk transaction may require the user to purchase insurance such as set out in the embodiment above or require an out of band user authentication or transaction approval. The terms set by the remote processing system may optionally be displayed alongside an indicator on the risk factor at the user terminal. The financial payment services may, for example, be a credit or debit card service or an online money transfer system.

In preferred embodiments, analysis takes into account aspects of the transaction including communication security, consumer security, validation of the vendor, shipping issues, interactions and relationship and product issues.

Embodiments of the present invention seek to address one or more of the following:
1. Identification of consumer risk while shopping online
2. offer them safe alternatives
3. support their decision
4. Offer system owners (bank, ISP, consumers) the opportunity to configure the engine according to their need and receive crucial data on consumer transaction risk + interact with the transaction to benefit the end consumer

Embodiments of the present invention seek to offer the consumer a method and system of reducing the risk associated with their decision. To achieve this, influences on a decision that take place are examined.

In one embodiment of the present invention, a risk assessment system is arranged to select and execute ones of a series of checks spanning the consumer's decision making process end to end wherein risk factors are interactively displayed on screen in a simple to understand format. From choosing a vendor, to selecting a product or simply making sure their environment is secure for a financial transaction, the system is in the background checking for issues and formulating solutions.

As issues are detected, preferably in a dynamic manner in response to progress through a transaction, embodiments of the present invention offer an assessment to the consumer along with a “safe alternative” button or link. If pressed, then the consumer will be presented with a list of safe vendors or products matching the consumer's exact criteria. The overall effect is that systems according to the present invention act as a guide, nudging the consumer away from known issues and towards safe registered alternatives.

Embodiments of the present invention may facilitate industry experts to provide the consumer with best advice in any specific circumstance e.g. what to watch out for when purchasing a life assurance policy, the correct height for a golf club or even DIY tips. The service will be available through a messaging system when no issues exist.

Here are a few examples of influences:—
Relationships and Levels of trust/honesty
Security in place for vendor, consumer and communication lines
Policies in place, legislation compliance, transparency
Service and product performance
What is on sale and are there any issues? Is the price ok? Is the product current?
   Decisions have to be made by the consumer. With all the external influences surrounding this decision, referred to as their decision space, the consumer needs to know most importantly where he is at risk.

Embodiments of the present invention seek to enable making of a decision where there was no decision possible before, for example where the consumer had a feeling but could never really quantify or qualify that moment Embodiments of the present invention seek to tangibly change a consumer's direction and conclusions in their physical world purchases. Changing their direction may be from one server or retailer to another or from one product to another. Embodiments may influence the user's physical device to display warnings, graphics alerts and an immediate risk assessment.

Advantages of embodiments of the present invention include:
The ability to apply a consumer decision engine across different aspects of the online transaction process e.g. searching for a product, reviewing a website, clicking the payment button etc.
The ability to identify the request at speed.
The ability to reproduce previous versions of the request at speed through the use of managed cache data.
The ability for the system to grow and learn through harmonising with the consumers machine with the greater system by receiving down loads, completing request pre-processing on the consumers
The ability for the system to “plug and play” new advancements in technology without the necessity of rolling out the technology to the end user but allowing the incorporation of this technology in, to better the accuracy of the system and delivery refined results.
The ability to support the total transaction from start to finish.
A system by which we can apply a score to any transaction for End-user Bank, insurance company, Consumer, ISP etc.
A physical event in the form of a screen animated character with varying colour, expression and body language instantly communicating to the end user that all is good to go or there are issues.

In one embodiment of the present invention, a method of validating of an online transaction includes processing factors from data on one or more of the purchaser, vendor, transaction mechanism, vendor website; determining a risk score from said processed factors and providing the end-user strategic information specific to their immediate decision.

Any single element of the checking process can be evaluated independently.

### BRIEF DESCRIPTION OF THE DRAWINGS

Embodiments of the present invention will now be described by way of example only and with reference to the accompanying drawings in which:

FIG. 1 is a schematic diagram of an internet transaction analysis system according to an embodiment of the present invention;

FIGS. 2a-2d are illustrations of indicators for use in displaying relative risk to a user at a user terminal;

FIG. 3a is an excerpt from a web page showing an indicator super-imposed over an ongoing transaction;

FIG. 3b is an illustration of user interface elements linking to a web page providing alternatives and risk analysis;

FIG. 4 depicts a set of possible relationships affecting a transaction;

FIG. 5 is a schematic diagram illustrating the processes performed by the processing unit;

FIG. 6a is an illustration of e-request types;

FIG. 6b is a diagram illustrating a user interface control for controlling e-request sensitivity;

FIG. 7 is a flow diagram illustrating check execution; and,

FIG. 8 is a schematic diagram illustrating risk assessment scoring.

### DETAILED DESCRIPTION OF CERTAIN EMBODIMENTS OF THE INVENTION

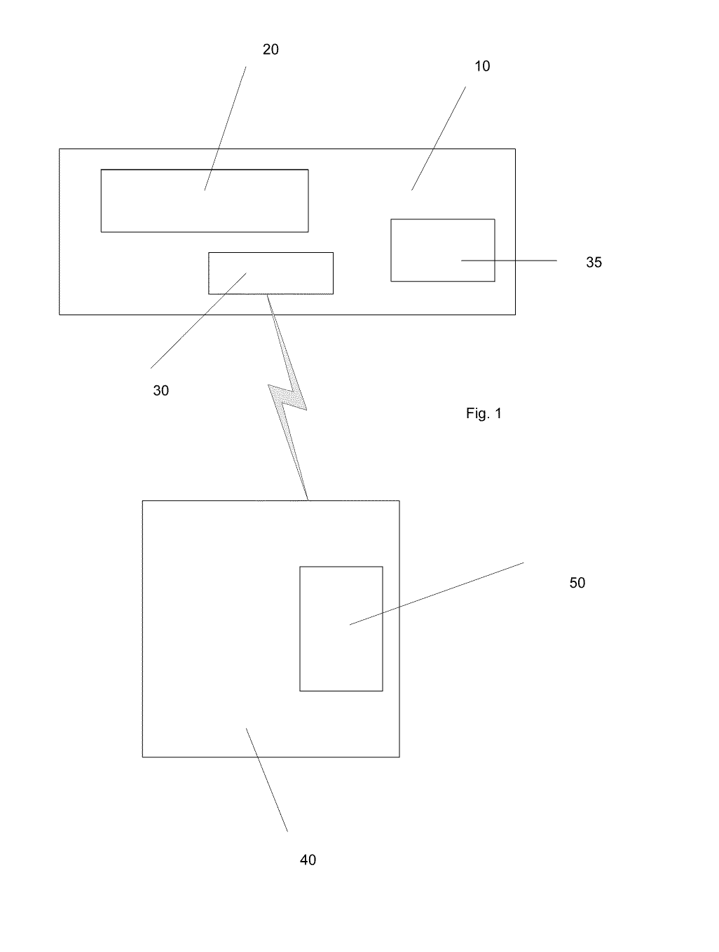

FIG. 1 is a schematic diagram of an internet transaction analysis system according to an embodiment of the present invention. The system 10 includes a processing unit 20 and a data communication arrangement 30. The processing unit 20 comprises computer program code that is configured (i.e., arranged) to receive, via the data communication arrangement 30, data on a transaction, the transaction being associated with internet activity at a remote user terminal 40. The system can comprise a computer having a processor and a memory that serves as a computer-storage medium to store code that executes to implement the certain functionalities that are described below, including those of the processing unit 20. In an embodiment, the processing unit is arranged using such code executing in the processing unit (e.g., in the form of one or more modules) to apply a plurality of checks to the data on the transaction, generate a value for a risk metric in dependence on the results of the checks and cause an indicator on the relative risk of the transaction to be output at the user terminal 40, the indicator of the relative risk being determined in dependence on the value for the risk metric.

Typically, the internet activity comprises web browsing. In such embodiments, the internet analysis system being arranged to cause the indicator 50 of the relative risk to be visible during said web browsing.

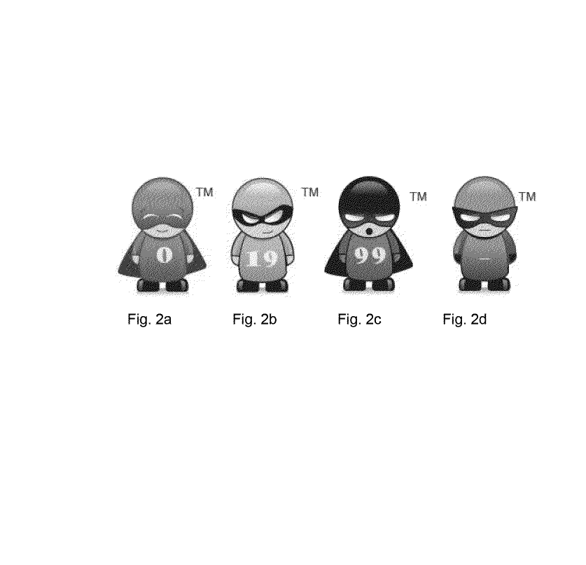

As shown in FIGS. 2a-2d, in preferred embodiments the indicator 50 preferably includes a graphical element that is varied in dependence on the relative risk being indicated. In FIG. 2a-2d, a series of indicators are shown with various different risk factors ranging from 0 in FIG. 2a (risk assessed to be safe, character depicted as happy and coloured green), to 19 (risk ok, character shown in amber to reflect raised risk), to 99 in FIG. 2c (very high risk, character shown in red, facial illustration is of concern). In FIG. 2d, the character is shown with no positive or negative facial or other features and a risk factor of “−”, illustrating that assessment has not yet been made or completed.

It will be appreciated that the embodiments of FIG. 2a-2d are merely illustrative and there are various ways in which the character could be varied in dependence on the relative risk being indicated. For example, the attributes may include: colour, facial expression; posture; dress; illustrated activity; animation; and, gesture. In addition, the character may be switched (in the super-hero variant illustrated, an arch-nemesis may be Illustrated for high risk situations) depending on risk factor.

Although the numeric value illustrated is not essential, it is a good indicator to show the user how good/bad the risk is. In addition, if the indicator is updated over time (to reflect changes in risk as a transaction progresses—discussed in more detail below), the numeric indicator may allow a finer granularity of change to be illustrated alongside the more general warnings provided by the character or other visual indicator.

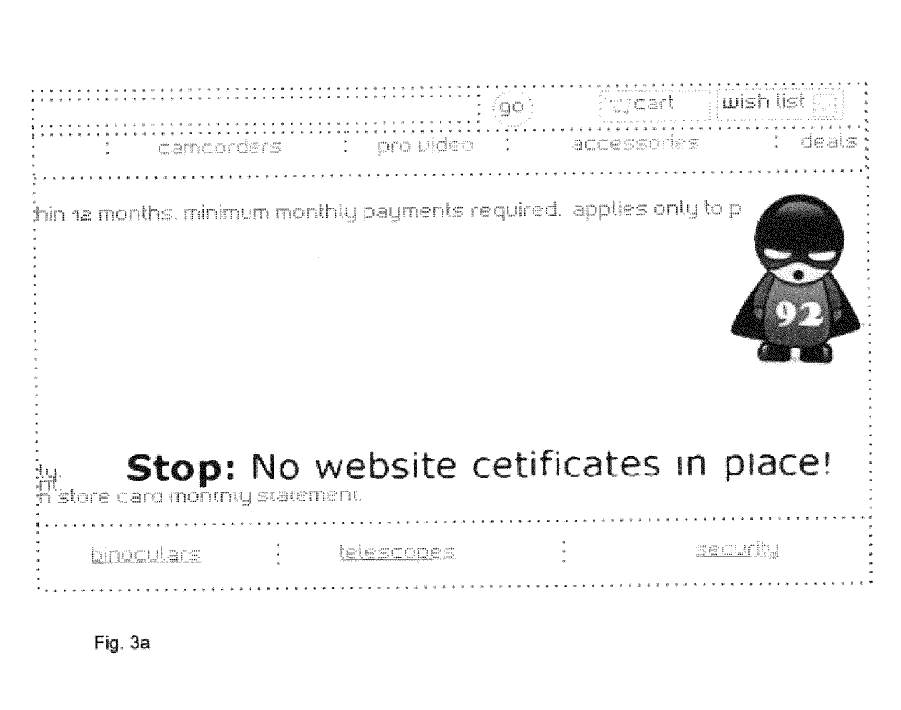

The indicator may be displayed in many ways. For example, it may be shown as part of a toolbar associated with the web browser; in a transparent layer superimposed over at least part of a web page (as shown in FIG. 3a) displayed by the web browser, a popup window or, as an icon in a taskbar of the remote terminal.

The indicator may be actuable by a user input at the remote user terminal (for example, it may be clickable, include a button or a link allowing risks or alternate sources of the product or service to be accessed). The indicator may be arranged to cause redirection of the web browsing activity to a respective alternative web site upon selection of the respective identifier by a user at the remote user terminal. FIG. 3b shows both a toolbar 51 and a web-layer indicator 52 linking to a summary page 53 of risks and alternatives. Note that the toolbar 51 and web-layer indicator 52 would typically be run on different user terminals and the illustration is simply to show the relationship between their respective functionalities.

Entities that may be subject to checks may include: a web server responding to said internet activity; an e-commerce system responding to said internet activity; an online payment system requested to process the transaction; the remote user terminal; an internet site that is target of the internet activity; a website that is target of the internet activity; an intermediary internet site that is party to the transaction; persons or companies linked to the internet site.

Although described in more detail below, the checks may be selected from a set including:

computer security; data transmission security; site data security, website security website compliance of predetermined standards; reputation of a company associated with the target; social media references to the target; physical location of a company or individual providing the target; presence of contact information on the internet site that is target of the internet activity: credit reference checks on the target.

In selected embodiments of the present invention, different modes of operation may be selectable or be triggered depending on activity and/or site visited by the remote terminal 40.

In active mode, the processing unit 20 is arranged to dynamically update the indicator 50 at the remote terminal 40 as issues arise or are addressed. As discussed above, this is preferably achieved by a graphical indicator 50 being overlaid on a webpage or other page or interface currently displayed on the display of the remote terminal 40, possibly with animation and supporting sounds.

The indicator may also show or link to a limited (typically up to 3) issues discovered by the assessment in order of severity.

In some embodiments, a web page for a banking or ISP system may not show the default indicator and instead includes an embedded display of the risk score and/or the top issues in a rolling message box. The bank and ISP versions may also show on the payments screen, particularly where the bank is acting as an intermediary credit card payment system for a website. In such an arrangement, the assessment is fed to the banking site and incorporated into the web page to be displayed to the user rather than being rendered at the remote user terminal separately to the website being visited. The banking site may communicate with the processing unit 20 to advise that the remote terminal 40 is visiting the banking website. This communication may then cause the processing unit to hide or otherwise change the indicator 50 to indicate that the assessment is being handled/displayed by the banking website.

In passive mode a graphic may be used depending on the system owner's requirements. For example, the graphic may be displayed on payment screens showing will be a risk assessment score and the top (typically 3 or 4) issues found.

Embodiments of the present invention preferably provide at least 3 levels of interaction to the consumer:

Level 1—Showstoppers: When a very serious issue is detected, where there is a very high likelihood that the transaction outcome will be detrimental to the consumer; the processing unit 20 causes the indicator 50 to alert the user that they should take action and leave this site. Here are a few examples:
This is a likely scam!
Find alternative vendor
This product is illegal!
Find alternative product

Level 2—Warnings: When the checks identify a deficiency in the decision process and there is potentially risk but there is also a possibility that the user could conclude with a healthy transaction, a warning is raised. Here are a few examples:—
Manufacturer Warrantees are not valid in UK!
Consider alternative UK vendor
This vendor does not comply with EU law!
Consider alternative vendor

Level 3—Advisory (preferably active mode only): When there is an opportunity to supply the consumer with industry specific helpful information, thereby enhancing their experience, advice is provided via the indicator—
When purchasing a camera:
consider the advice from expert http://ww..,
When purchasing a bicycle helmet
Bicycle helmet straps should fit as follows http:ww.

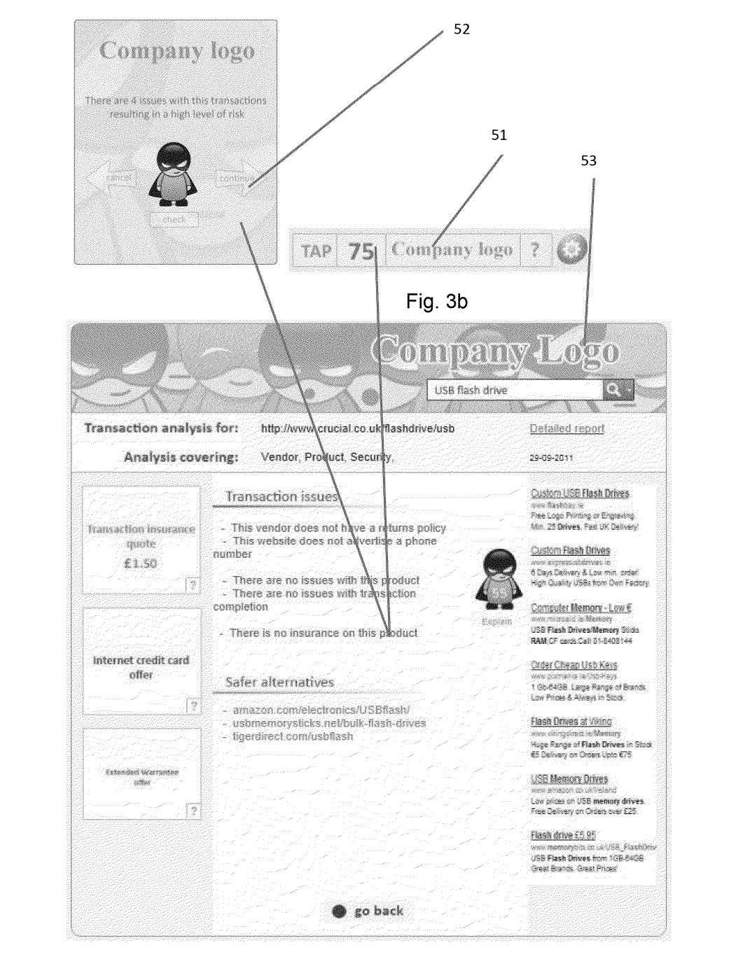

FIG. 4 depicts a set of possible relationships affecting a transaction.

The dashed line represents functionality provided by embodiments of the present invention and the role it plays in the transaction. Where an external influence 100 is shown, at least one check would be made by the processing unit 20.

Preferably, risk is presented in the form of a risk score, for example a number between 0 and 100.

Preferred embodiments assess risk using a risk engine whereby a single input, in the form of an examination request (e-request), is received and a single output is returned, in the form of a risk score.

Preferably, an e-request may be submitted and processed in respect of any entity that may influence a transaction. For example, a web page, product, reviewer, company, domain, delivery service, Credit Card Company, blog, advisor. Preferably, for every entity checked i.e. product, reviewer, company, website, shipper etc, a unique identification number is created by the processing unit 20 and stored in a data repository 35 linking to data on the assessment.

In preferred embodiments, a user interface is provided enabling the entity owner can manage this identity. The assessment score can be managed by interaction via the user interface and addressing issues that may have been raised. In the same way as web search engine rankings are managed and improved, so too can assessment scores. Optionally, websites may provide direct links to the assessment via the unique identifier. In this manner, the possibility that the processing unit may classify two e-requests differently is minimised and the speed of which results are returned is increased (as product/service classification does not need to be done).

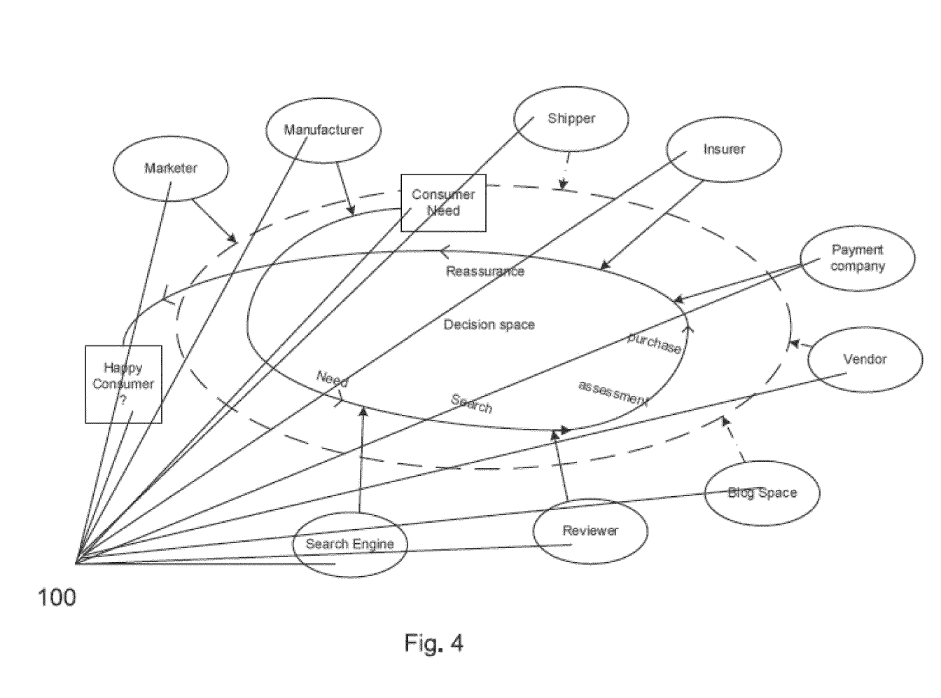

FIG. 5 is a schematic diagram illustrating the processes performed by the processing unit 20 in performing checks to assess risk according to an embodiment of the present invention.

While the processing unit and check data may be centralised, it is also possible that some elements (such as databases checked, definitions of the checks to be made etc) may be remote. Indeed, it may be that a number of different processing units 20 serve set remote user terminals. Data may be accessed from its source on-demand or alternatively, it may be pushed out or pulled down to the respective processing units in dependence on a particular schedule. To improve response times, selected data may be pre-processed. For example, a database of the most popular E-requests may be provided to the processing unit 20 (or for that matter to each remote user terminal) such that when a transaction is initiated, the check has already been made and an indicator can be immediately be displayed. In selected embodiments, a subset of checks may be pre-performed (for example those on the user terminal or those on the particular site being visited) such that only transaction specific checks need to be performed in order to complete the assessment.

In preferred embodiments of the present invention, a request for assessment can be submitted from various routes including via an API, via a server request, interfacing to a bank, ISP, search engine or from a consumer browser add-on. E-requests can come from any physical device, mobile phone, computer, server, any chip and board that have a network card with internet access.

Preferably, the processing unit returns at least a risk score (a single number between 1 and 100). This score is a value based on the summation of all checks performed. The level of importance, weightings, the tolerances on each check and the type of check is taken into account and is preferably configurable (with the exception of very serious issues (show stoppers).

An e-request may be in the form of a top level URL, or a URL to a product/Product code or a URL to a specific page or a product code, or a company name or a bar code, or a unique identification number?

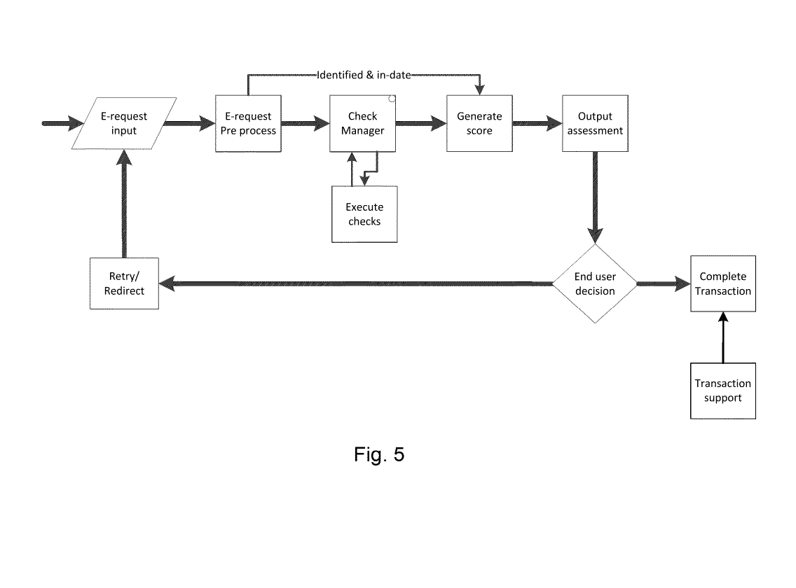

As shown in FIG. 6a, the processing unit 20 operates three levels of requests, all described as “E-requests”.
Level 1—Global request that required the execution of many check categories
Level 2—The execution of a specific check category
Level 3—The execution of a specific check

The level of request sent to the processing unit 20 directs the operation of the processing unit Note that a level 1 E-Request is made up of multiple Level-2 E-Requests. Level-2 E-Request is made up of multiple Level-3 E-Requests. For example, if the E-Request is for a product name or product code, then this is likely to have been categorised as a level-2 E-request which would then be executed. If the request is the URL page of a product with the same product code, then a level-1 check is also executed for the domain of the URL.

A level 2 request would cause multiple level 3 requests to be performed. As discussed above, any pre-existing level 3 requests would be re-utilised where applicable and any missing requests would be scheduled for execution.

Each new e-request that is received is pre-processed to identify whether it is a new request or a full or partial repeat of one that has already been performed. Pre-processing applies to all three levels of e-requests.

Preferably, pre-processing includes validity checks to see if the request is in a correct format. Pre-processing attempts to identify the level of e-request; the identity of the entitylentities to examined and then checks to see if a unique identifier for the/each entity has been stored in the data repository 45 are made. If a generic class of product or service can be identified, a check may also be made to identify a unique identifier in the data repository for that class.

If pre-processing identifies that an entity involved in the e-request as having been executed before then this is taken into account in subsequent processing.

If the specific request has been performed before, it is identified. If not, the request is identified and catalogued.

In the event that the e-request cannot be immediately identified, the next step is to identify the category of checks that are necessary for this particular request by first identifying the entity under examination. If the request is specific e.g. a product, then all necessary product checks are associated with this request to be executed in the checking phase.

If there are many categories associated with the request, one of the categories may have been examined before i.e. A URL to a purchase page requires the checking of the domain, the product and the security, one of the categories may already have a history on the system, the product was already checked by another end user using another website URL.

Preferably, the Identification process happens through a process or elimination. Is there a URL address attached? Is it a root domain address? Is there a product code or picture attached? Has the reviewer signed his name? Cross references are made to both internal databases and known external databases.

For every new e-request, it is examined to see if the entity being examined has a profile in the data repository. If not, a profile is created.

The relationship between levels may be dependent on the requests themselves. For example, certain level 3 requests may be mandatory for assessment of a level 2 request. In one example, certain level 3 requests may be set as mandatory and must be executed (or have previous execution results available for use). Others may be designated as being optional. In one embodiment, a threshold number of level 3 checks may be needed (so 3 may be mandatory and 10 in total may be needed for a “valid” level 2 request assessment.

In the case of level 1 requests, it may not logistically be possible to prescribe specific level 2 request results. For example, it may not be possible to designate products to be assessed to perform a request for a specific online retailer (whose stocks may in any event change). In such an instance, assessment may be based on a random (or guided) selection of products, it may be on less variable issues (such as on the retailer itself) and/or it may be formed from checks already executed. For example, a returns policy would be applicable to a particular product but would also have more general applicability to the retailer assessment.

Preferably, each executed request may be given a predetermined lifetime. Once the lifetime of an executed request has expired, it may need to be re-executed before contributing to a new assessment. In selected embodiments, multiple lifetimes may be associated with a request and as subsequent lifetimes expire, a confidence factor may be applied to the assessment to reflect the reduced usefulness.

FIG. 6b is a diagram illustrating a user interface control for controlling e-request sensitivity. In preferred embodiments, a user may designate via a user interface such as the one illustrated, a level of sensitivity of checks to be executed/displayed. For example, requests may be performed only at global level only such that an assessment is performed and displayed immediately before purchase (typically shown at the checkout or purchase page). At a greater level of sensitivity, requests may be performed for each individual page visited. At a still greater level of sensitivity, the displayed risk may be refreshed as individual checks are executed (described as “check by check”).

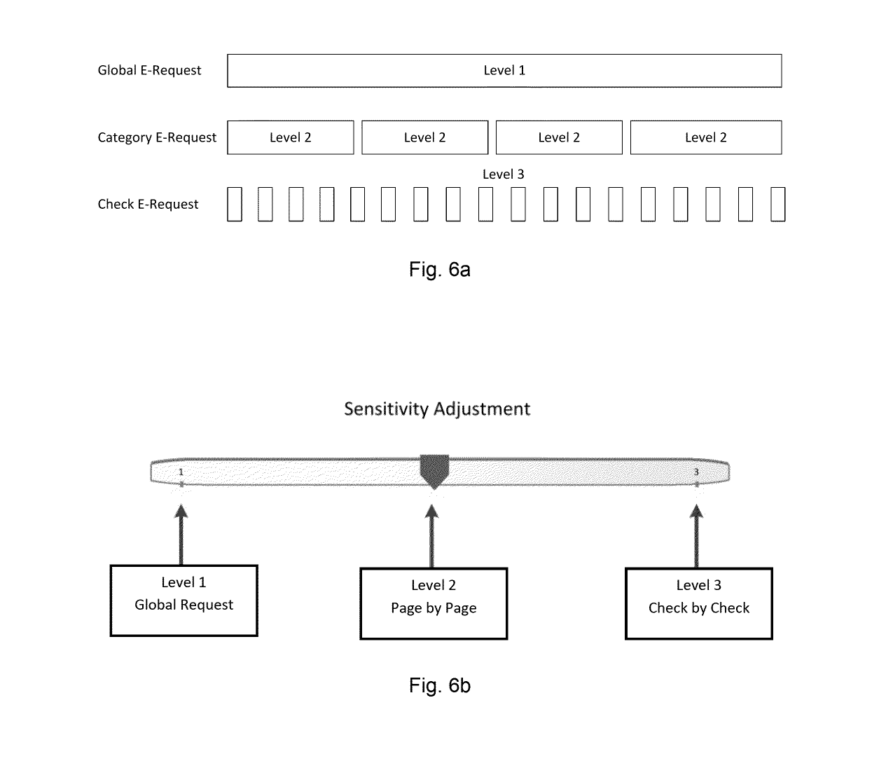

Both new and previously examined e-requests are the passed to the next, check execution, step, illustrated in FIG. 7.

In the check execution step, checks are assigned for each e-request. If an e-request has already been identified and recognised, it is then checked to see it is within a predetermined validity date range or it is has or expired. If it is in date, then the previous assessment score is retrieved from the data repository 45.

Each check has an order of priority assigned to it. A default time per examination is set. If this time is close to expiring then a time trigger is activated, bypassing the remaining checks. In this manner, results can be returned to a user within a predetermined time window.

Note that there are 3 levels of E-Requests, Global request, Category request and check request giving 3 opportunities for the system to bypass the execution stage.

Level 1—Global E-Request that required the execution of many check categories

A global e-request can be recognised by a reference database detailing the exact request entries to the system. In this scenario, if a history is found on the system and it is still in date then all other processes are bypassed and the score is passed to the scoring process (E.g. A top level domain name is examined).

Level 2—Category E-Request—The execution of a specific check category

A Category check can be recognised by a reference database detailing the exact request entries to the system. In this scenario, if a history is found on the system and it is still in date then all other processes are by past and the score is passed to the scoring process. E.g. A specific product is examined.

Level 3—The execution of a Check e-request (entry of company number followed by “registration”) Individual check:—a reference database will allow the end user to ask a question for analysis by an embodiment of the present invention. For example:—a consumer wants to know the companies house details of a specific company. They will need to enter the company registration number followed by the word Registration. The system could return all registration checks executed.

Sub-categories may optionally be introduced.

The checking process will be occurrence-based with the most regular checks placed in a batch process as required. Frequency of occurrence will be a major influence on the scheduling of checks.

In one embodiment, individual check scoring is represented as a percentage. Most scores are of a binary nature, they are either wrong or right i.e. 0—positive result 100—Negative result. If there are multiple facets to a check, the allocation of a percentage for each facet will be examined on a case by case basis.

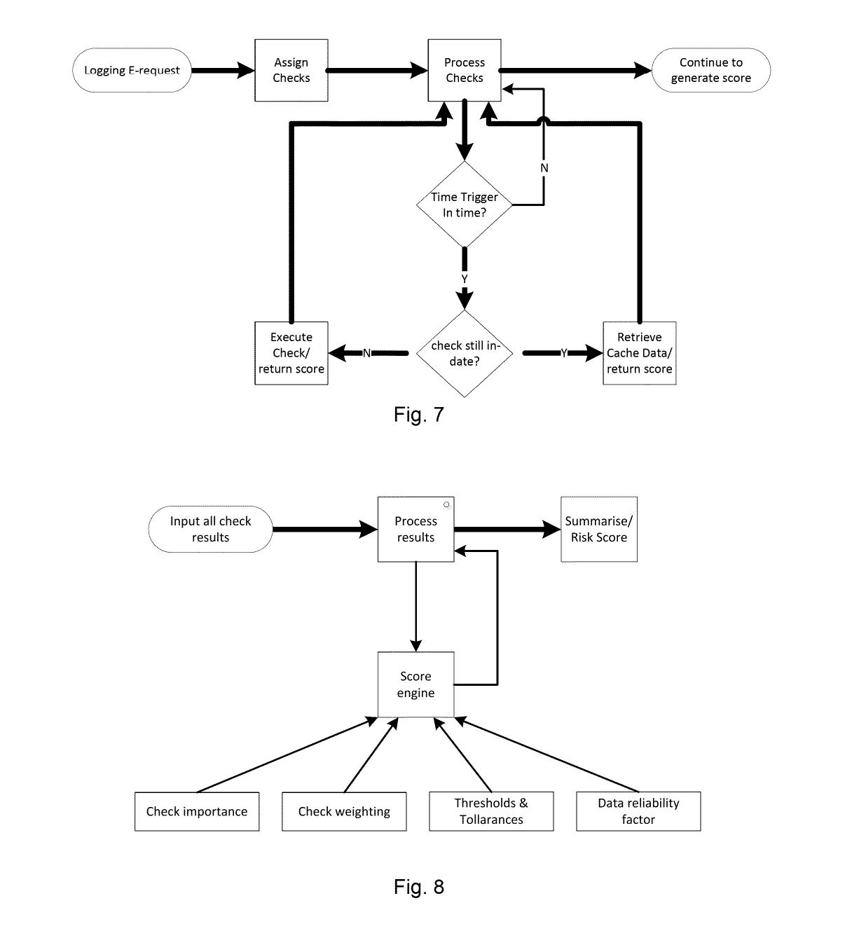

Once checks have been executed, a combined risk assessment score is generated, as is illustrated in FIG. 8. Preferably:

Each check has a process priority—this sets the process order for the check

Each check has an importance—this sets the maximum score than can be applied for this check

Each check has a weighting factor—this allows a variable weight been applied by a system owner

Each check has a reliability factor—allowing an external statistic feed on data quality to apply to the check

As discussed above, there are many ways to categorise and display risk values. In one embodiment, classifications may be based on risk score as follows:

0-10 minor issues
11-70 generates warning messages
71-100 Major issue (show stopper)

Checks are preferably processed in order of priority. Each check returns what is referred to as a raw score (in this embodiment a score between 0—good and 100—bad). In selected embodiments, an importance factor is then applied by multiplication and then division by 100. For example, if the importance factor for a check is set to 20 and the raw score is 100 then the risk score so far is 20. If the raw score was 50 then the risk score would then be 10. Weighting and reliability factor may be applied in a similar way.

Each check value is then added to the risk check score. If the overall score reached 100 then there is no need to continue processing.

The indicator may be dynamically updated as each check returns its result (so the user may see the risk score counting up or down as checks are performed).

Checks may be made by the processing unit 20 locally or outsourced to remote checking systems or made by the processing unit 20 against remotely held data.

Many checks can be made available and their selection or application could, for example, be dependent on user profile, subscription level etc. Checks may be made automatically for all transactions (or all transactions of a particular type) or dependent on settings of the userfinancial authority triggering the checks. Preferably, the checks each have a weighting and the outcome of the checks contributes to the overall risk assessment score. In selected embodiments, checks may be grouped and the weighting from each group may be normalised with respect to that of other groups before being combined to produce the risk assessment score. In such an arrangement, no one group can overly affect the final score. Normalised scores may also be weighted such that more important groups contribute more strongly to the assessment than those of less importance.

In one embodiment, override settings may be associated with checks such that predetermined results of the check may cause a predetermined risk assessment score irrespective of results of other checks (for example, if the target site is run by a company registered as being bankrupt then this may immediately cause a base risk factor of 90 out of 100 to be set). It may be in such a situation that no further checks are performed or it may be that the other checks are performed such that positive results may reduce the assessed risk (or other checks may increase it).

Example Checks May Include:

Company Checks: Is vendor a Company with a Companies Register; are company accounts filed with national authority and up to date; country of registration of company; status of company on companies register; date of incorporation; company type (e.g. Sole Trader, Private Limited Co (Ltd), Public Limited Co (Plc.), Limited Liability Partnership (LLP)); name changes of company.

Domain Checks: Creation date of the domain name; Expiry date of the domain name; country of the organization the domain is registered to; comparison of the business's country with the domain owner's country.

Contact Checks: is a contact telephone number published on site; is telephone number a non-premium rate number; is a business address published; is a VAT and company registration number displayed.

Website Marketing Checks: does the website comply with the Advertising Standards Authority, and distance selling regulations.

Website Reference Checks: positive or negative reference by consumer watchdog service; website listed on blacklist databases Advisor); score and/or average scores from user review sites; presence of Malware on site; presence of viruses on site; history of Malware or viruses on site; history of producing unsolicited emails (spam).

Company/website accreditation checks: site is giving expert advice and showing appropriate qualifications/Association/certification to support that expert advice; trade or professional association membership and qualifications are displayed appropriate for product; site is displaying a trust mark with in date information: compliance with the Children's Online Privacy Protection Act (COPPA); no recorded data breaches for this site; existence of website policy privacy policy; existence of a returns policy; existence of a cooling off period policy; existence of a refund policy; existence of a complaints policy; existence of user privacy controls over stored data; use of encryption for stored user data.

Website customer services checks: existence of a method for feedback; existence of a method for complaints; display of Ombudsman details and/or a regulatory body reference; shipping costs not declared until checkout (post registration); shipping costs are reasonable; shipping cost include transport insurance.

Product/Service Checks: Known product issues exist; Known product recalls exist; a more recent version of the product is available; product is dependent on another part: product meets EU quality standards; product has a green rating: price of the product is within average internet norms; manufacturer is identifiable; product is still supported by the manufacturer: online support is available: online manual is available: product release date is within industry norms for product type; life expectancy of the product is within industry norms of product type; cost of ownership (services, replacement parts e.g. toothbrush heads) is within industry norms for this product type; product is labelled correct and honestly cost of return is reasonable; no known exploitation associated with this product; child safety rating.

Product/Service Region Checks: country/region the product is compatible with (e.g. Power supply, DVD media encoding; Intellectual Property rights); website offers complete service to the user terminal location; no additional charges are incurred because of user terminal location; no warrantee restrictions or charges incurred because of user terminal location.

Transaction Completion Checks: A HTTPS secure connection is used for the payment transaction: Correct SSL certificates are in place; consumer has been identified; consumer identity has been verified

Credit card is not listed on illegal Credit Card sale sites; Transaction is covered by section 75 legislation (>100); alternate insurance for transaction is in place e.g. PayPal®; an unsecured hotspot is being used; a public network is being used; no firewall is used; remote terminal settings are not appropriate to complete transaction; no virus scanner installed on remote user terminal or details out of date: no recent virus scan of remote user terminal; browser phishing defence is not turned on.

Information supplier and ISP Checks

Blog, Review and chat board Checks: reviewer has been identified; information has no time/date stamp; information is not signed; information source has known issues in the past; Blogger, Reviewer or writer received payment for publishing information; information supplied is current.

Web checks: ISP is filtering traffic; search engine is recording personal details, IP address and personalizing traffic to browser; ISP is tracking data; website meets .net coding standards and/or W3C standards; no endless Loops; no missing links; no error messages displayed: no login problems.

Preferably, for every entity checked i.e. product, reviewer, company, website, shipper etc. a unique identification number is created. The entity owner can manage this identity. They can affect their score by communicating directly with the system and address the specific issues that have been raised. The entity owner should ensure that the ID is readily available to access (displayed) by the risk engine or directly by the consumer.

In one embodiment, the system may use a central (or distributed) database.

Data is transmitted between the system and a toolbar or other component or user interface element on the user's device.

The toolbar/component/element is used by the user to identify the need, product or service the user is searching for. In particular this will be enhanced by natural search technologies as they become available.

To obtain validation results, the system queries data in the database and/or obtains the result from third party systems from information sent to it from the toolbar. Checks performed will be selected from a large pool of available checks and the selection will be dependent on factors such as desired speed, available processing power, context of the query.

The following are a list of possible validation scenarios and possible outcomes when an embodiment of the present invention is used.

Interactions Check—In the summer Mary wanted to go see a band. She is searching for concert tickets online. She finds a site that has tickets available but at a cost. The system checks records for the company and discovers there are none. Via a character displayed on her browser, the system immediately informs Mary that there are no company records for this site and recommends alternative ticket sites to use.

Interactions Check—Jo wanted to read a review about a specific product. He found a blog entry on a website that lists reviews for the product he had an interest in. The system flagged up via a visual and audible indicator that there was an issue that the blog was unsigned and undated. The review turned out to be an advert put out by the manufacturer. An alternative reliable source is offered via the toolbar on the Jo's PC for reviews for the same product.

Interactions Check—John received an email purporting to be from his bank asking him to check his account because of potential fraud. A link was provided in the email to “perform the check”. John opened his email client, downloaded the email and clicked the link which took him through to a replica site in his web browser. In rendering the site in the web browser, data on the site is copied to the system which flagged up that it was hosted outside of the country (Ip address).

Security Check—After a friends recommendation, Fred is about to purchase from a website in the UK. The product looks good and the site so far looks good. When Fred hits the buy button, a character displayed in the browser indicates that independent purchase insurance is available for this transaction. As Fred wishes to use a debit card (for which purchase insurance is not provided in the UK), he elects to add the purchase insurance.

Security Check—Michael is looking for a product on a major retailer website. He uses the site regularly to purchase products. He presses the link to a third party site expecting no issue due to past experience and the size of the retailer. During one of the checks, it is identified and flagged to Michael that the company who owns this web site has filed with companies house for bankruptcy.

Preferred embodiments or the present invention seek to provide mechanisms for alerting the user to elements of risk. However, in alternate embodiments (or in a service provided in addition to the preferred embodiments), financial products and other services resultant on the checks may also be offered. For example, credit card purchases are currently covered by purchase insurance in some jurisdictions. In one embodiment, optional purchase insurance may be offered to the purchaser at the time of the transaction, the assessment score being used to determine what charge band (or percentage of the transaction) should apply for the insurance. Thus, a secure transaction with a reputable dealer would likely be cheaper than one made via an ecommerce website that was situated overseas and offered no SSL encryption for transaction traffic (indeed in such situations the score may be so low that insurance is not offered at all).

For example, an Insurer may set up a profile in the data repository 45 that defines an insurance product based on risks they may cover. The Insurer can also configure settings to prevent offering insurance on certain transactions such as those posing high risk transactions. IP addresses and locations that are not in the UK, specific product etc. The risk assessment score may be taken into account when calculating insurance premium cost.

Similar functionality may be offered through new credit or debit card services—a bespoke credit or debit card may be offered in which online transactions quoting that card number are automatically routed to the system for assessment (even if the user does not use the software in his browser etc) and approval of the transaction is dependent on the transaction meeting a predefined threshold score on the assessment. Optionally or alternatively, discounted or free purchase insurance could be automatically included for online purchases that use the card and system for assessment.

For example, a credit card may be offered that is limited to certain risk types (and may have appropriate rewards/charges to the user based on the risk profile). For example, the card may have:

an authorised IP address usage;
authorised geographical regions;
accessibility only through authorised devices;
access restricted to user terminals logged on at the processing unit 20:
extended transaction data to combat fraud, including chargeback fraud: and/or
transaction based insurance built-in for all transactions (dependant on risk levels).

Although the processing unit has been described as a central service remote from the user terminal, in other embodiments of the present invention, its functionality may be distributed across multiple systems or servers. Additionally, at least elements (and potentially all) of its functionality could be provided in implements such as:

A dedicated decision processor with network card i.e. onsite black box

Installable software activated via a licence

Installable applications on end user terminal activated via a licence

Question and answer server presented as a search engine

It will be appreciated that the systems described herein may be implemented in software, hardware, firmware or some combination thereof by a single computing system or a combination of locally connected or remotely connected computer systems. The software can comprise code or other instructions that execute in the processor of the computer to configure the processor to perform the functions described herein. The code can comprise one or more instructions, programs, libraries, functions or routines which, for purposes of this specification, are described in terms of a plurality of modules that implement different parts of the process described herein. In arrangements consistent with the foregoing, one or more of the modules can be combined or additional modules provided. Code which implements one or more of the functions described herein can be stored on a computer readable storage medium of the type noted above. For avoidance of doubt, a computer readable storage medium does not include a transitory signal.

What is claimed is:

1. An internet transaction analysis system comprising a processing unit and a data communication arrangement, the processing unit being arranged to receive, via the data communication arrangement, data on a transaction, the transaction being associated with internet activity at a remote user terminal, the processing unit being arranged to apply a plurality of checks to the data on the transaction, generate a value for a risk metric in dependence on the results of the checks and cause an indicator on the relative risk of the transaction to be output at the user terminal, the indicator of the relative risk being determined in dependence on the value for the risk metric.

2. An internet transaction analysis system as claimed in claim 1, wherein the internet activity comprises web browsing, the internet analysis system being arranged to cause the indicator of the relative risk to be visible during said web browsing.

3. An internet transaction analysis system as claimed in claim 2, wherein the indicator includes a numeric value corresponding to the value for the risk metric.

4. An internet transaction analysis system as claimed in claim 1, wherein the indicator is displayed at the remote user terminal in one or more of a toolbar associated with the web browser; a transparent layer superimposed over at least part of a web page displayed by the web browser, a popup window or, a taskbar of the remote terminal.

5. An internet transaction analysis system as claimed in claim 2, wherein the indicator is actuable by a user input at the remote user terminal.

6. An internet transaction analysis system as claimed in claim 5, wherein the indicator is arranged, in response to actuation, to display data at the remote user terminal on the relative risk.

7. An internet transaction analysis system as claimed in claim 1, further comprising a user terminal component arranged to be executed at the remote user terminal and, upon execution, to cause data on said internet activity to be transmitted to said data communication arrangement.

8. An internet transaction analysis system as claimed in claim 1, wherein the data communication arrangement is arranged to receive data on the transaction from one or more remote systems party to the transaction.

9. An internet transaction analysis system as claimed in claim 8, wherein the one or more remote systems include ones selected from a set including: a web server responding to said internet activity; an e-commerce system responding to said internet activity; an online payment system requested to process the transaction.

10. An internet transaction analysis system as claimed in claim 1, wherein the checks are performed on targets selected from a set including:
the remote user terminal; an internet site that is target of the internet activity; a website that is target of the internet activity; an intermediary internet site that is party to the transaction; persons or companies linked to the internet site.

11. An internet transaction analysis system as claimed in claim 10, wherein the checks performed on one or more of the targets are selected from a set including:
computer security; data transmission security; site data security; website security; website compliance of predetermined standards; reputation of a company associated with the target; social media references to the target; physical location of a company or individual providing the target; presence of contact information on the internet site that is target of the internet activity; credit reference checks on the target.

12. An internet transaction analysis method comprising:
receiving data on a transaction, the transaction being associated with internet activity at a remote user terminal,
applying a plurality of checks to the data on the transaction;
generating a value for a risk metric in dependence on the results of the checks; and,
causing an indicator on the relative risk of the transaction to be output at the user terminal, the indicator of the relative risk being determined in dependence on the value for the risk metric.

13. A method as claimed in claim 12, wherein the internet activity comprises web browsing, the method including causing the indicator of the relative risk to be visible during said web browsing.

14. A method as claimed in claim 13, wherein the indicator includes a graphical element, the method including varying the element in dependence on the relative risk being indicated.

15. A method as claimed in claim 14, wherein the graphical element includes a representation of a character, one or more attributes of the character being varied in dependence on the relative risk being indicated.

16. A method as claimed in claim 15, wherein the attributes include:
facial expression; posture; dress; illustrated activity; animation; and, gesture.

17. A method as claimed in claim 14, wherein at least a part of the indicator is coloured, the colour being varied in dependence on the relative risk being indicated.

18. A method as claimed in claim 13, further comprising identifying one or more alternative web sites relevant to the internet activity and having a lower relative risk and causing an identifier for each of said one or more alternative web sites to displayed to the user at the remote user terminal.

19. A method as claimed in claim 18, further comprising causing redirection of the web browsing activity to a respective alternative web site upon selection of the respective identifier by a user at the remote user terminal.

20. A method as claimed in any of claim 12, further comprising causing the outputted indicator to be updated over time in response to internet activity at the remote user terminal.
